(19) United States
(12) Patent Application Publication
(10) Pub. No.: US 2025/0142443 A1
(43) Pub. Date: May 1, 2025

(54) REPLACEMENT OF A SANITARY DEVICE

(71) Applicant: Geberit International AG, Jona (CH)

(72) Inventors: Florian Portmann, Männedorf (CH); Roland Oberholzer, Uster (CH); Daniel Raissle, Altendorf (CH)

(21) Appl. No.: 18/931,024

(22) Filed: Oct. 29, 2024

(30) Foreign Application Priority Data
Oct. 31, 2023 (EP) 23207167.0

(51) Int. Cl. H04W 36/38; H04L 67/125; H04W 4/38; H04W 36/30

(52) U.S. Cl. CPC H04W 36/38; H04L 67/125; H04W 4/38; H04W 36/30

(57) ABSTRACT

The present invention relates to a method for replacing a sanitary device assigned to a gateway and communicatively connected thereto, comprising the following method steps carried out by the gateway: obtaining and storing a configuration of the sanitary device, identifying that the sanitary device is no longer communicatively connected to the gateway, identifying a second sanitary device which is not assigned to the gateway, determining a type of the second sanitary device, comparing the type of the sanitary device on the basis of the stored configuration with the determined type of the second sanitary device, determining that the type of the sanitary device and the type of the second sanitary device match, and loading the stored configuration of the sanitary device to the second sanitary device.

### FIELD

The present invention relates to a method for replacing a sanitary device and a gateway to execute steps of the method.

### BACKGROUND

Sanitary devices such as toilets, urinals, washbasin taps, shower and bathtub taps, hygiene flushes and the like are known from the state of the art, which offer extended functionality and, for example, allow configuration with regard to the operating parameters to be used. For this purpose, the aforementioned sanitary devices comprise electronic controls by means of which this extended functionality is realized.

If a sanitary device needs to be replaced, this may also mean that an electronic control unit installed in it is also replaced. This is problematic because values for operating parameters for the sanitary device are stored in the memory of the electronic control unit, which must be available for continued use even after the sanitary device has been replaced by a device of the same design or type. Until now, such a configuration of a replaced sanitary device cannot be automatically transferred to a new sanitary device, especially without the use of third-party devices (such as the smartphone of a sanitary installer or service technician).

This is particularly disadvantageous in the case of a networked system comprising a large number of sanitary devices, as a sanitary installer or service technician carrying out the replacement would have to have access to the system in order to be able to transfer a configuration to the new sanitary device, i.e. to the electronic control system of the same.

### BRIEF DESCRIPTION OF THE DRAWINGS

FIG. 1 shows a schematic overview of a system comprising several sanitary devices.

FIG. 2 shows a flow chart showing an embodiment example of the method according to the invention.

FIG. 3 shows a flow chart, an embodiment example for the optional execution of a firmware update as part of the method according to the invention.

FIG. 4 shows a schematic block diagram of an embodiment example of a gateway according to the invention.

### DETAILED DESCRIPTION

Against the above-mentioned background, a problem addressed by the present invention is to provide a solution that enables a sanitary installer or service technician to continue using an existing configuration for a sanitary device acting as a replacement device without specific IT-related specialist knowledge, without access rights to a given system and without manually setting individual parameters.

According to the invention, this problem is solved by a method for replacing a sanitary device assigned to a gateway and communicatively connected thereto, comprising the following method steps carried out by the gateway: obtaining and storing a configuration of the sanitary device, identifying that the sanitary device is no longer communicatively connected to the gateway, identifying a second sanitary device which is not assigned to the gateway, determining a type of the second sanitary device, comparing the type of the sanitary device on the basis of the stored configuration with the determined type of the second sanitary device, determining that the type of the sanitary device and the type of the second sanitary device match, and loading the stored configuration of the sanitary device onto the second sanitary device.

The above solution is based on the realization that if the configurations of all sanitary devices connected to a gateway are automatically stored by the gateway, neither access rights to such a system, in which the sanitary device is integrated, nor an additional, in particular manual, work step are required when replacing a sanitary device that includes a corresponding electronic control unit. This can drastically reduce the requirements placed on the personnel carrying out a replacement, as no specialist knowledge is required to reconfigure a sanitary device acting as a repair replacement.

Advantageously, the obtaining and storing of the configuration of the sanitary device is performed if the sanitary device is assigned to the gateway for the first time. In this way, it can be ensured that a configuration of a sanitary device is immediately available when it is initially integrated into an existing system.

Preferably, the obtaining and storing of the configuration of the sanitary device is performed if at least one parameter of the configuration of the sanitary device has been modified. This ensures that the gateway does not have any outdated information that could be used for a replacement device.

In a preferred embodiment, the gateway modifies at least one parameter. In this way, the gateway itself initiates a configuration change for the sanitary device so that a correspondingly updated version of the configuration is available.

Advantageously, the at least one parameter was modified by a user device communicatively connected to the sanitary device, in particular by an application thereof. In such a scenario, for example, a user device accesses the sanitary device directly, e.g. by means of a wireless connection (such as Bluetooth). To ensure that changes to the configuration are recorded by the gateway for storage, it can also be provided that the gateway retrieves and stores the configuration of the sanitary device at predefined intervals.

Preferably, an assignment to the gateway is given if the sanitary device has been assigned a logical address, in particular as part of an initial enumeration. Since a logical address is always assigned to a sanitary device by the gateway, this serves as an indicator that an assignment has already been made if a logical address is available for a sanitary device.

In a preferred embodiment, the method also comprises loading a firmware update on the second sanitary device and initiating a restart of the second sanitary device before loading the saved configuration on the second sanitary device. This has the advantage that in the case of a second sanitary device equipped with outdated firmware, which serves as a replacement device, it can be avoided that an incompatible configuration of the replaced sanitary device is loaded. For example, a firmware update can mean that certain parameters of a configuration are no longer available and/or new parameters have been added.

Advantageously, the sanitary device is a WC, a shower toilet, a urinal, a washbasin fitting, a shower or bathtub fitting, an odor extraction system, a hygiene flush, an electronic cistern actuation system, a hygiene flush unit, a temperature sensor, a pressure sensor, a volume sensor, a mirror cabinet (which, for example, has functions relating to ventilation, heating, surface heating, and/or a face or user ID), a lighting unit or an electronic control unit included in one of the aforementioned devices. Particularly in the case of an arrangement of a large number of similar sanitary devices (such as a large number of urinals), the solution according to the invention allows a single device to be replaced easily. If the sanitary device is one of the aforementioned sensors, it can also be provided that such a sensor is connected directly to the gateway, which simplifies the identification of a communicative disconnection and the identification of a replacement device.

Preferably, the configuration comprises a) product-specific parameters, in particular type, physical location of the sanitary device, position within an arrangement with other sanitary devices, assigned logical address, b) usage-specific parameters, in particular number of days of use, number of flushes, number of uses, and/or c) setting-specific parameters, in particular flush time, run-on time, interval flushing interval, interval flushing flush time, surge flushing interval, surge flushing flush time, cleaning time. The color of an illumination device, for example, can also be provided as a setting-specific parameter if a sanitary device includes one or is one itself.

In a preferred embodiment, a bus system, in particular by means of communication via EIA-485 or RS-485, is provided for the communicative connection of the gateway and the sanitary device. The use of a bus system is advantageous, as reliable communication can be realized in this way.

Advantageously, an intermediate converter is provided for the communicative connection between the gateway and the sanitary device. Such a converter enables devices to have a simpler and therefore more cost-effective communication interface. Communication via the bus system is nevertheless possible, as a converter can be connected to a large number of devices, for example up to five devices.

Preferably, an Inter Device Connection (IDC), in particular by means of communication via I²C, is provided for the communicative connection of the converter and the sanitary device. This allows a comparatively low implementation effort on the part of a sanitary device.

In a preferred embodiment, the method further comprises issuing a notification when it is determined that the type of the sanitary device and the type of the second sanitary device do not match. For example, the gateway itself can display such a notification on a display, issue an acoustic notification via a loudspeaker of the gateway or send a message, for example by e-mail, to an addressee stored in the gateway. Alternatively or additionally, it can be provided that a notification is issued or displayed by a user device, in particular by means of an application of the same.

Furthermore, the aforementioned problem is solved according to the invention by a gateway comprising a processor, a memory and a communication unit, wherein the gateway is set up to receive a configuration from a sanitary device which is assigned to the gateway and communicatively connected thereto (i.e. in particular), to identify that the sanitary device is no longer communicatively connected to the gateway, to identify a second sanitary device which is not assigned to the gateway, to determine a type of the second sanitary device, to compare the type of the sanitary device with the determined type of the second sanitary device on the basis of the stored configuration, to determine that the type of the sanitary device and the type of the second sanitary device match, and to load the stored configuration of the sanitary device onto the second sanitary device.

According to an alternative embodiment, it may be provided that the gateway and the sanitary device to be replaced are communicatively connected to each other exclusively by means of a radio link (e.g. via Bluetooth). In such a case, the method according to the invention can be partially automated by using a second sanitary device after the sanitary device has been taken out of service. A sanitary installer or service technician then presses a button provided on the gateway, which puts the gateway into a pairing process in which a connection can be made with new devices such as the second sanitary device. An application provided on a user device, such as a smartphone, of the sanitary installer or service technician is then used to establish a connection from the user device to the gateway. Without specifying a password or other information, the application displays the second sanitary device recognized in the meantime by the gateway, which is still in pairing mode, which, after selecting a corresponding function (e.g. “terminal replacement” or “repair replacement”), prompts the sanitary installer or service technician to enter a serial number for both the replaced sanitary device and the replacing sanitary device, which is physically applied to the respective sanitary device, for example in the form of a sticker or similar. Using these serial numbers, the gateway ultimately loads the configuration of the sanitary device to the second sanitary device.

In this way, a sanitary installer or service technician can replace a sanitary device without extensive IT knowledge and install a configuration on the replacement sanitary device.

Further details, features and advantages of the invention are explained in more detail with reference to the following embodiment examples.

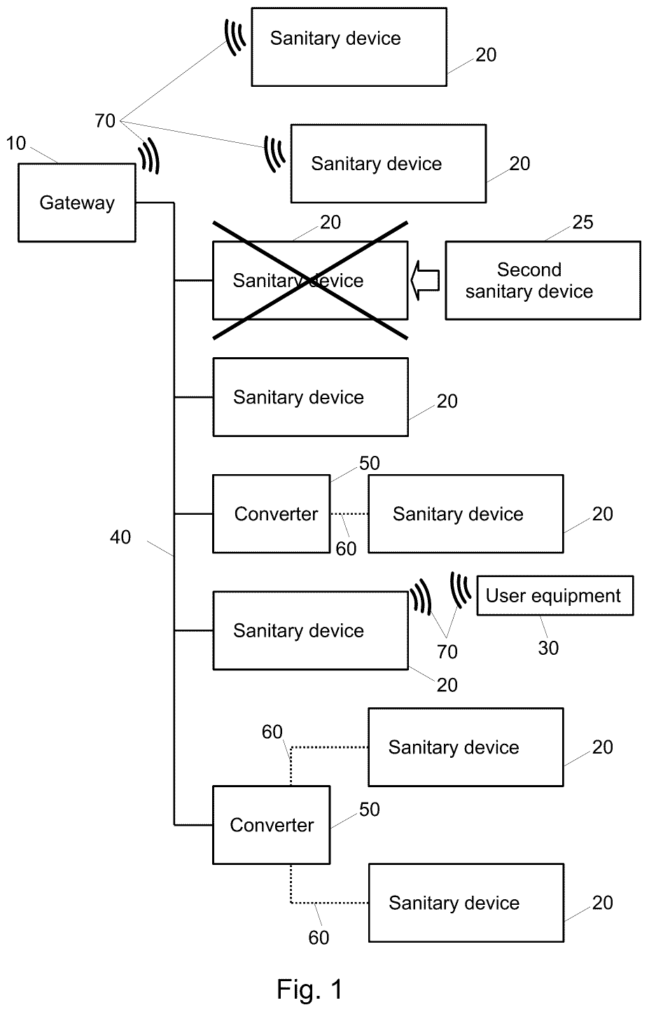

FIG. 1 shows a schematic overview of a system comprising several sanitary devices 20, which are communicatively connected to a gateway 10. A bus system 40 is provided for the connection in this case.

The sanitary devices 20 are either connected directly to the gateway 10 via the bus system 40 or by means of a converter 50. A converter 50 itself acts as a participant in the communication bus, i.e. it is connected directly to the bus system 40, but also establishes a communicative connection to one or more sanitary devices 20, in this case by means of an inter-device connection, for example via an inter-integrated circuit (I²C). The gateway 10 has information about which sanitary devices 20 can be reached via which converter 50, i.e. are connected to it.

Furthermore, FIG. 1 shows that sanitary devices 20 can also be connected directly to the gateway 10, for which a wireless connection 70, for example via Bluetooth, is provided. Such a connection of the sanitary devices 20 is suitable if the local conditions do not allow the use of a connection via a bus system 40.

A wireless connection 70 can be provided not only between the gateway 10 and sanitary devices 20, but also between a sanitary device 20 and a user device 30, which is, for example, the smartphone of a sanitary installer or service technician. This allows direct access to the sanitary device 20, for example to change or read out data from it.

FIG. 1 shows schematically that a sanitary device 20 is no longer communicatively connected to the gateway 10, which is illustrated by the corresponding crossed-out element. The fact that a second sanitary device 25, which is not yet assigned to the gateway 10, is to serve as a repair replacement for this is illustrated by the arrow shown next to it.

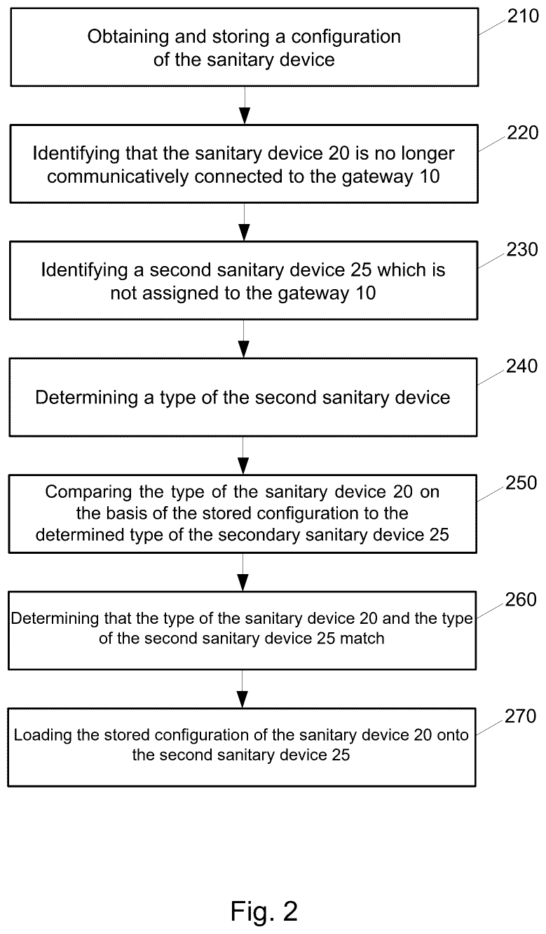

FIG. 2 shows a flow chart of an embodiment of the method according to the invention. The method can be applied to a communication structure as shown in FIG. 1. In the initial state, a sanitary device 20 is assigned to a gateway 10 and communicatively connected to it.

According to method step 210, the gateway 10 receives a configuration of the sanitary device 20 and stores it. This method step is performed, for example, if the sanitary device 20 has been assigned to the gateway 10 for the first time or if at least one parameter of the configuration of the sanitary device 20 has been modified.

The at least one parameter may have been modified by the gateway 10 or by a user device 30 communicatively connected to the sanitary device 20, in particular by means of a wireless connection 70. Furthermore, it may also be provided that the gateway 10 receives and stores a configuration of the sanitary device 20 at predefined intervals.

Then, in method step 220, it is identified that the sanitary device 20 is no longer communicatively connected to the gateway 10. The end of a communicative connection can be triggered, for example, by the sanitary device 20 being disconnected from the power supply.

A second sanitary device 25, which is not, i.e. not yet, assigned to the gateway 10, is then identified in accordance with method step 230. For this purpose, the gateway 10 checks, for example, whether devices that have not yet been assigned a logical address can be reached via communication. The assignment of a logical address for sanitary devices 20 can take place, for example, as part of an initial enumeration.

In the subsequent method step 240, the gateway 10 determines a type of the second sanitary device 25, which was previously recognized. The determined type of the second sanitary device 25 is compared in method step 250 with the type of the sanitary device 20, which is no longer communicatively connected to the gateway 10. A comparison is possible because the gateway 10 has the configuration of this sanitary device 20, which also includes its type.

After the gateway 10 determines in method step 260 that the type of the sanitary device 20 and the type of the second sanitary device 25 match, a loading of the stored configuration of the sanitary device 20 onto the second sanitary device 25 is performed in method step 270. In this way, for example, the logical address of the replaced sanitary device 20 is adopted by the replacing second sanitary device 25.

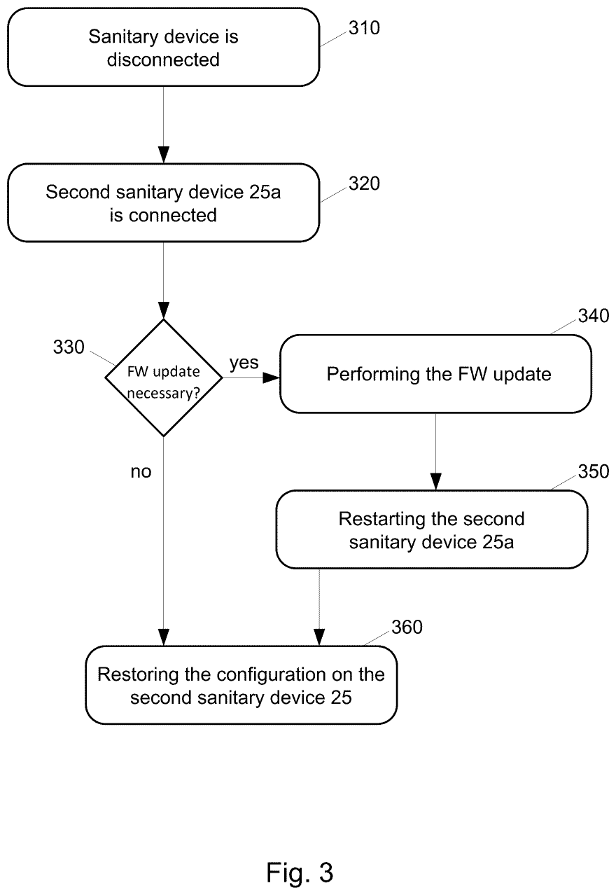

FIG. 3 shows a flow diagram of an embodiment example for the optional execution of a firmware update as part of the method according to the invention. In method step 310, the sanitary device 20 is first disconnected from the gateway 10, i.e. the sanitary device 20 is no longer communicatively connected to the gateway 10.

The second sanitary device 25 is then connected to the gateway 10 in method step 320. This includes, for example, establishing a power supply for the second sanitary device 25 and connecting it via bus system 40.

Subsequently, in method step 330, the gateway 10 checks whether a firmware update needs to be carried out for the second sanitary device 25. For this purpose, the gateway 10 compares the version of the firmware that is present on the second sanitary device 25 at this time with the latest version of the firmware known to the gateway 10. The gateway 10 can obtain information regarding the latest version of a firmware for different types of sanitary devices, for example, independently via the Internet.

If a firmware update is necessary, this is carried out in method step 340 by transmitting corresponding data from the gateway 10 to the second sanitary device 25, and the second sanitary device 25 receives a command to process this data. Subsequently, i.e. after completion of the firmware update, the second sanitary device 25 is restarted in method step 350.

After the firmware for the second sanitary device 25 has been updated to the current version, the gateway 10 initiates the restoration of the configuration on the second sanitary device 25 in accordance with method step 360.

This prevents an incompatible configuration of the replaced sanitary device being loaded if the second sanitary device is equipped with outdated firmware, for example due to removed and/or newly added parameters.

However, in the event that the gateway 10 determines in method step 330 that the firmware version present on the second sanitary device 25 already corresponds to the version which the gateway 10 considers to be current, method steps 340 and 350 are not carried out, but a restoration of the configuration on the second sanitary device 25 is performed directly in accordance with method step 360.

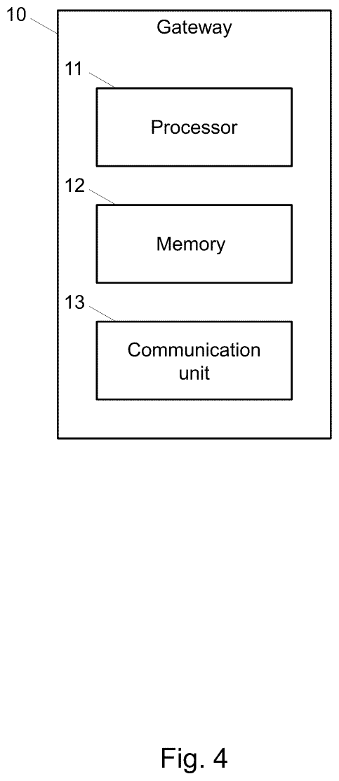

FIG. 4 shows a schematic block diagram of an embodiment of a gateway 10 according to the invention.

The gateway 10 has a processor 10 with which operations of the gateway 10 are controlled. Furthermore, the gateway 10 has one or more memories 12, which are used on the one hand to store an operating system of the gateway 10 and on the other hand allow the storage of configurations received from sanitary devices 20. Furthermore, one or more communication units 13 are provided in the gateway 10. On the one hand, a connection via bus system 40 is possible and, on the other hand, a wireless connection 70, in particular to individual sanitary devices 20, can be established.

The figures described above and the embodiment examples explained in connection therewith serve only to explain the invention and are not limiting with respect thereto.

### List of Reference Symbols

The following reference symbols are used and defined as follows in this description:
10 Gateway
11 Processor of the gateway
12 Memory of the gateway
13 Communication unit of the gateway
20 Sanitary device(s)
25 Second sanitary device (as replacement)
30 User equipment
40 Connection via bus system
50 Converter
60 Connection via Inter Device Connection
70 Wireless connection
210-270 Method step
310-360 Method step

### Summary of Example Embodiments

The following is a summary of example embodiments that have been described above:
1. A method for replacing a sanitary device assigned to a gateway and communicatively connected thereto, the method comprising, by the gateway:
   obtaining and storing a configuration of the sanitary device,
   identifying that the sanitary device is no longer communicatively connected to the gateway,
   identifying a second sanitary device which is not assigned to the gateway,
   determining a type of the second sanitary device,
   comparing the type of the sanitary device on the basis of the stored configuration with the determined type of the second sanitary device,
   determining that the type of the sanitary device and the type of the second sanitary device match, and
   loading the stored configuration of the sanitary device to the second sanitary device.
2. A method according to example 1, wherein the obtaining and storing the configuration of the sanitary device is performed if the sanitary device has been assigned to the gateway for the first time.
3. A method according to example 1 or example 2, wherein the obtaining and storing of the configuration of the sanitary device is performed if at least one parameter of the configuration of the sanitary device has been modified.
4. A method according to example 3, wherein the at least one parameter has been modified by the gateway.
5. A method according to example 3, wherein the at least one parameter was modified by a user device connected communicatively, in particular by means of a wireless connection, to the sanitary device, in particular by an application thereof.
6. A method according to one of examples 1 to 5, wherein an assignment to the gateway is given if the sanitary device has been assigned a logical address, in particular in the context of an initial enumeration.
7. A method according to any one of examples 1 to 6, further comprising loading a firmware update to the second sanitary device and causing a restart of the second sanitary device prior to loading the stored configuration to the second sanitary device.
8. A method according to one of examples 1 to 7, wherein the sanitary device is a WC, a shower toilet, a urinal, a washbasin fitting, a shower or bathtub fitting, an odor extraction system, a hygienic flush, an electronic cistern actuation system, a hygienic flush unit, a temperature sensor, a pressure sensor, a volume sensor, a mirror cabinet, an illumination device or an electronic control provided in one of the aforementioned devices.
9. A method according to any one of examples 1 to 8, wherein the configuration comprises
   product-specific parameters, in particular type, physical location of the sanitary device, position within an arrangement with other sanitary devices, assigned logical address,
   user-specific parameters, in particular number of days of use, number of flushes, number of uses, and/or
   setting-specific parameters, in particular flush time, run-on time, interval flushing interval, interval flushing flush time, surge flushing interval, surge flushing flush time, cleaning time.
10. A method according to one of examples 1 to 9, wherein a bus system is provided for the communicative connection of gateway and sanitary device, in particular by means of communication via EIA-485 or RS-485.
11. A method according to one of examples 1 to 10, wherein an intermediate converter is provided for the communicative connection of gateway and sanitary device.
12. A method according to example 11, wherein an inter-device connection, in particular by means of communication via I²C, is provided for the communicative connection of the converter and the sanitary device.
13. A method according to any one of examples 1 to 12, further comprising: issuing a notification upon determining that the type of the sanitary device and the type of the second sanitary device do not match.
14. A gateway comprising a processor, a memory and a communication unit, wherein the gateway is arranged to:
   receive a configuration from a sanitary device which is assigned to the gateway and communicatively connected to the gateway,
   identify that the sanitary device is no longer communicatively connected to the gateway,
   identify a second sanitary device which is not assigned to the gateway,
   determine a type of the second sanitary device,
   compare the type of the sanitary device on the basis of the stored configuration with the determined type of the second sanitary device,
   determine that the type of the sanitary device and the type of the second sanitary device match, and
   load the stored configuration of the sanitary device to the second sanitary device.

What is claimed is:

1. A method for replacing a sanitary device assigned to a gateway and communicatively connected thereto, the method comprising, by the gateway:
obtaining and storing a configuration of the sanitary device,
identifying that the sanitary device is no longer communicatively connected to the gateway,
identifying a second sanitary device which is not assigned to the gateway,
determining a type of the second sanitary device,
comparing the type of the sanitary device based on the stored configuration with the determined type of the second sanitary device,
determining that the type of the sanitary device and the type of the second sanitary device match, and
loading the stored configuration of the sanitary device to the second sanitary device.

2. A method according to claim 1, wherein the obtaining and storing the configuration of the sanitary device is performed if the sanitary device has been assigned to the gateway for the first time.

3. A method according to claim 1, wherein the obtaining and storing of the configuration of the sanitary device is performed if at least one parameter of the configuration of the sanitary device has been modified.

4. A method according to claim 3, wherein the at least one parameter has been modified by the gateway.

5. A method according to claim 3, wherein the at least one parameter was modified by a user device connected communicatively, in particular by means of a wireless connection, to the sanitary device, in particular by an application thereof.

6. A method according to claim 1, wherein an assignment to the gateway is given if the sanitary device has been assigned a logical address in the context of an initial enumeration.

7. A method according to claim 1, further comprising loading a firmware update to the second sanitary device and causing a restart of the second sanitary device prior to loading the stored configuration to the second sanitary device.

8. A method according to claim 1, wherein the sanitary device is a WC, a shower toilet, a urinal, a washbasin fitting, a shower or bathtub fitting, an odor extraction system, a hygienic flush, an electronic cistern actuation system, a hygienic flush unit, a temperature sensor, a pressure sensor, a volume sensor, a mirror cabinet, an illumination device or an electronic control provided in one of the aforementioned devices.

9. A method according to claim 1, wherein the configuration comprises
product-specific parameters, in particular type, physical location of the sanitary device, position within an arrangement with other sanitary devices, assigned logical address,
user-specific parameters, in particular number of days of use, number of flushes, number of uses, and/or
setting-specific parameters, in particular flush time, run-on time, interval flushing interval, interval flushing flush time, surge flushing interval, surge flushing flush time, cleaning time.

10. A method according to claim 1, wherein a bus system is provided for the communicative connection of gateway and sanitary device, in particular by means of communication via EIA-485 or RS-485.

11. A method according to claim 1, wherein an intermediate converter is provided for the communicative connection of gateway and sanitary device.

12. A method according to claim 11, wherein an inter-device connection, in particular by means of communication via I²C, is provided for the communicative connection of the converter and the sanitary device.

13. A method according to claim 1, further comprising: issuing a notification upon determining that the type of the sanitary device and the type of the second sanitary device do not match.

14. A gateway comprising a processor, a memory and a communication unit, wherein the gateway is arranged to:
receive a configuration from a sanitary device which is assigned to the gateway and communicatively connected to the gateway,
identify that the sanitary device is no longer communicatively connected to the gateway,
identify a second sanitary device which is not assigned to the gateway,
determine a type of the second sanitary device,
compare the type of the sanitary device based on the stored configuration with the determined type of the second sanitary device,
determine that the type of the sanitary device and the type of the second sanitary device match, and
load the stored configuration of the sanitary device to the second sanitary device.
